(19) United States
(12) Patent Application Publication
(10) Pub. No.: US 2024/0033960 A1
(43) Pub. Date: Feb. 1, 2024

(54) RAZOR COMPONENTS

(71) Applicant: BIC Violex Single Member S.A., Anoixi (GR)

(72) Inventors: Panagiotis KOPELAS, Anoixi (GR); Ioannis BAGOURDAS, Anoixi (GR); Maria-Thiresia ZANIDAKI, Anoixi (GR); Nikolaos CHRYSANTHAKOPOULOS, Anoixi (GR)

(73) Assignee: BIC Violex Single Member S.A., Anoixi (GR)

(21) Appl. No.: 18/360,473

(22) Filed: Jul. 27, 2023

(30) Foreign Application Priority Data
Jul. 29, 2022 (EP) 22187841.6

(51) Int. Cl. B26B 21/52

(52) U.S. Cl. CPC B26B 21/521

(57) ABSTRACT

A razor head holder is provided. The holder comprises a holder structure including a connector for a razor head, the holder structure further including a helical screw-in member configured for a piercing connection with a razor handle including an engaging portion comprising at least one of cork; a compound of cork, wood, and/or bamboo fiber/power with a plastic matrix; and thermoplastic or thermoset material with a shore hardness between 30A-60D.

### CROSS REFERENCE TO RELATED APPLICATIONS

This application claims benefit from European patent application EP 22187841.6, filed on Jul. 29, 2022, the entirety of which is incorporated herein by reference.

### TECHNICAL FIELD

The present disclosure relates to razor head holders, kits of parts, methods of assembling a razor and methods of disassembling a razor.

### BACKGROUND

Safety razors with multiple blades have been known for quite some time. However, there is an ongoing effort to improve the properties of modular razors. Moreover, safety razors and their cartridges should be produced in a resource efficient manner.

### SUMMARY

In a first general aspect, the present disclosure relates to a razor head holder comprising a holding structure including a connector for a razor head, the holder structure further including a helical screw-in member configured for a piercing connection with a razor handle including an engaging portion comprising at least one of cork; a compound of cork, wood, and/or bamboo fiber/power with a plastic matrix; and thermoplastic or thermoset material with a shore hardness between 30A-60D, preferably 70A.

In a second general aspect, the present disclosure relates to a kit of parts, comprising a razor head holder according to the first general aspect, and a razor handle wherein the razor head holder is coupled to the razor handle razor cartridge including at least one cutting member.

In a third general aspect, the present disclosure relates to a method of assembling a razor, comprising the steps of:
a) providing a razor head holder according to the first general aspect,
b) providing a razor handle including an engaging portion comprising at least one of cork; a compound of cork, wood, and/or bamboo fiber/power with a plastic matrix; and thermoplastic or thermoset material with a shore hardness between 30A-60D, preferably 70A, and
c) aligning the razor handle with an engagement axis of the screw-in member and relatively rotating the razor handle and the razor head holder to connect the razor head holder and the razor handle by screwing the screw-in member in the razor handle.

In a fourth general aspect, the present disclosure relates to a method of disassembling a razor, comprising the steps of:
a) providing a razor assembled according to the method of the third general aspect, and
b) relatively rotating the razor handle and the razor head holder in a direction opposite to an assembling direction until the razor handle and the razor head holder are disconnected.

Particular examples of the first to fourth general aspects can be implemented so as to realize one or more of the following advantages.

First, the razor head holder and the razor handle can be easily assembled by just screwing or rotating the cork body of the razor handle onto the helical screw-in member of the razor head holder or by screwing the helical screw-in member into the cork body. The design and process reminds of a cork screw for wine bottles. Further, the present disclosure provides the possibility to disassemble the razor handle and attach a new one when the first handle has been worn off. Assembling and disassembling can be achieved by a user without any extra tools.

Second, there is no need to have a hole or any connector at the cork handle for the connection with the razor head holder. The cork handle only needs an end face with a planar surface. Thus, no hole or connector features are needed which are difficult to control and inspect. Further, the manufacturing process of a solid handle is simpler and quicker than of a handle with a hole or an internal thread.

Third, the razor handle and the razor head holder can be manufactured in a more resource-efficient manner in some examples as only a simple cork rod is provided for the razor handle. Cork is a natural, environmentally friendly material. It biodegrades completely and can be easily recycled without producing any toxic residues.

Certain terms are used in the following manner in the present disclosure: The expression “connected to” is not limited to a direct connection between two objects (i.e., it is not required that the two objects abut). For instance, a first object and a second object can be indirectly connected through a third object (e.g., a cutting edge portion can be indirectly connected to an edge of the base portion through another component such as a blade mounting portion).

The expression “extending at an angle” relates to an angle which is smaller than 180° (e.g., smaller than 160°). Moreover, the expression “extending at an angle” specifies that the first object extending at an angle and the second object from which the first object extends inscribe the angle (e.g., the base portion extends in a first vertical direction and the cutting edge portions and the base portion define an inscribed angle). The expression “extending at an angle” includes but does not require direct contact between the first object extending at an angle and the second object from which the first object extends.

The term “edge” refers to a boundary limiting an object (e.g., the base portion). This does not necessarily mean that there is a material boundary. For instance, the base portion can be directly connected to blade mounting portion (e.g., these elements can be formed from the same sheet of material) but nevertheless there can be an edge limiting the base portion.

The term “fixedly attached” relates to a permanent or non-detachable attachment. For instance, a weld connection or an adhesive can be used to fixedly attach two objects. Two objects connected by a screw connection or a clip connection or by friction/releasable pressing forces, on the other hand, are not “fixedly attached”.

### DESCRIPTION OF THE DRAWINGS

FIG. 1 illustrates a razor head holder according to the present disclosure.

FIG. 2 illustrates a razor head holder and a razor handle according to the present disclosure.

FIG. 3 illustrates a modular razor including the razor head holder and the razor handle according to the present disclosure.

### DETAILED DESCRIPTION

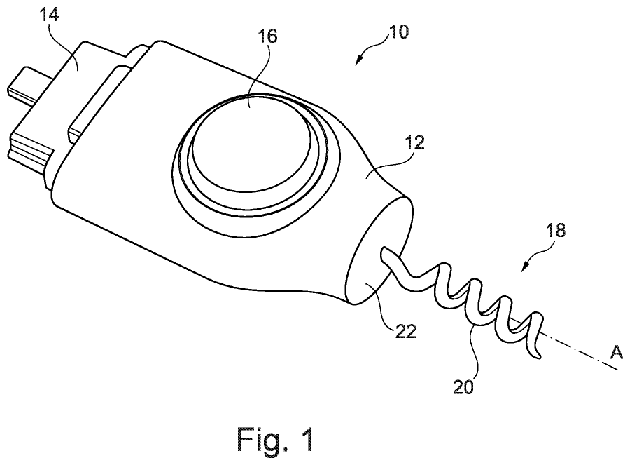

FIG. 1 shows a perspective view of a razor head holder 10 according to the present disclosure.

As shown in FIG. 1, the razor head holder 10 comprises a holder structure 12 configured to couple the razor head holder 10 to a razor head or a razor cartridge. To that end, the razor head holder 10 includes a connector 14 for a razor head. The connector 14 or the connection can be released using a mechanism 16 e.g., in form of a press button or the like.

The mechanism 16 can be located on a main face of the holder structure 12 or the razor head holder 10, respectively. The connector 14 can be located at an end face of the holder structure 12 or the razor head holder 10, respectively.

The razor head holder 10 further comprises a helical screw-in member 18 configured for a piercing connection with a razor handle including an engaging portion comprising cork. The screw-in member 18 includes a helical body 20 which can comprise or consist of steel or plastic material and can have a sharp tip configured to pierce the engaging portion of the razor handle. The helical body 20 can be wound or formed along an engagement axis A. The helical body can have the shape of a corkscrew. The material of the screw-in member 18 or its helical body 20 can comprise plastic material for example “ABS” or elastomeric material, or silicone.

The screw-in member 18 is protruding from a stop surface 22 of the holder structure 12 or the razor head holder 10, respectively. The stop surface 22 can be located at a further end face of the holder structure 12 or the razor head holder 10, respectively. The stop surface 22 can be located opposite to the end face in a direction of the engagement axis A. The screw-in member 18 can be molded with the holder structure 12. The screw-in member 18 could also be a separate component mounted on the holder structure 10 by any other known connection means.

The stop surface 22 provides a stop for a razor handle when it is attached to the razor head holder 10 by screwing or rotating. The stop surface 22 can have a circular shape to ease orientation of the razor handle with the razor head holder 10. The stop surface 22 can also have an oval or triangle/polygonal shape depending on the section of the holder structure. It could be any of these or similar shapes that would allow a handle to rotate freely inside or above the stop surface 22.

The stop surface 22 can have a size being identical or larger than the size of an end face of the razor handle. This can ensure that the end face of the razor handle rests completely on the stop surface 22 for improved stability.

The screw-in member 18 can have a length of at least the diameter or a span (either the largest, the shortest or a span in between) of the stop surface 22. Such ratio can increase stability of the connection between the razor handle and the razor head holder 10.

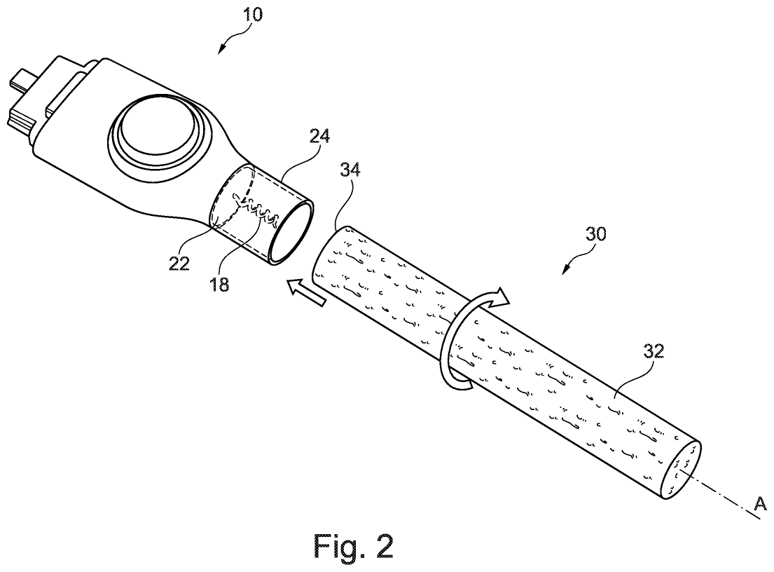

FIG. 2 shows a perspective view of a razor head holder 10 and a razor handle according to the present disclosure. The razor head holder 10 is in most parts identical to the razor head holder shown in FIG. 1.

In addition to the razor head holder shown in FIG. 1, the razor head holder 10 shown here comprises a handle guide 24 which surrounds the screw-in member 18. The handle guide 24 can have a shape in form of a hollow cylinder with a middle or rotational axis corresponding with the engagement axis A. In this way, the handle guide 24 surrounds the screw-in member 18 like a wall. The handle guide 24 can be provided at a boundary or rim of the stop surface 22.

In this example, the handle guide 24 has a circular shape. The handle guide 24 can also have an oval or triangle/polygonal shape depending on the section of the holder structure. It could be any of these or similar shapes that would allow a handle to rotate freely inside or outside the handle guide 24. The stop surface 22 and the handle guide 24 may have the same shape or boundary.

The handle guide 24 can have a circular shape while the handle has a triangle section where the three edges of the handle just contact the internal surface of the circular handle guide. In examples, the handle guide could be triangular while the handle has a circular section where the cylindrical surface of the handle just contacts the three internal planar surfaces of the triangular handle guide. Thus, the handle could be inserted into the handle guide or the handle guide could be inserted into the handle.

The shape of the handle guide and the handle could vary across their length without a constant section.

The handle guide 24 guides the razor handle 30 in the process of assembling it or connecting it with the razor head holder 10. Further, it stabilizes the razor handle 30 when it is connected with the razor head holder 10. Even further, the handle guide 24 can protect the screw-in member 18. Especially, when the handle guide 24 projects farther from the stop surface 22 than the screw-in member 18. Additionally, the handle guide 24 can protect the user's fingers from injury when the handle guide 24 projects farther from the end of the screw-in member 18.

The razor handle 30 includes an engaging portion 32 comprising for example cork and being adapted to engage e.g., pierce with the screw-in member 18 of the razor head holder 10. The razor handle 30 can completely consist of cork. Then, the engaging portion 32 forms the razor handle 30. The razor handle 30 can have a rod like or cylindrical shape. Instead of cork, a compound of cork, wood, and/or bamboo fiber/power with a plastic matrix; and thermoplastic or thermoset material with a shore hardness between 30A-60D, preferably 70A can be utilized.

The razor handle 30 can have an end face 34 with a size being identical or smaller than the size of the stop surface 22 of the razor head holder 10. This combination allows for easy assembly and disassembly.

The razor handle 30 can have an end face 34 with a planar surface without a recess for the screw-in member 18. Due to the appearance of the screw-in member 18 no connector or opening or thread is needed on the razor handle 30 for a connection. The screw-in member 18 can pierce the end face 34 of the razor handle 30 when the two parts are engaging.

There could also be a possibility to have a hole in the end face of the razor handle for guidance or for decreasing the effort of penetration especially in case of a plastic handle. Such hole or indentation can have a depth not increasing the diameter of this hole. Further, such hole could assist in achieving a connection with press-fit force rather than penetration. In all cases, no thread is present. As described, a recess without a thread may be present.

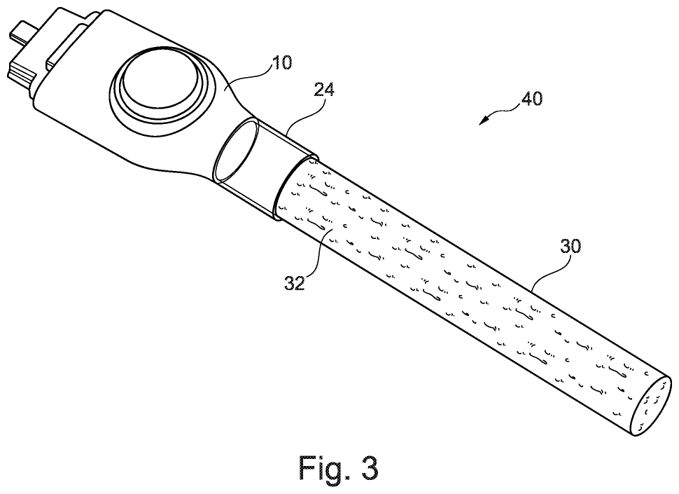

FIG. 3 shows a perspective view of a modular razor 40 including the razor head holder 10 and the razor handle 30 according to the present disclosure. The modular razor 40 can equal to a kit of parts including the razor head holder 10 and the razor handle 30 wherein the razor head holder 10 is coupled to the razor handle 30. The parts 10 and 30 can correspond to the razor head holder 10 and the razor handle 30 as depicted in FIG. 2.

The expression modular razor 40 can include the razor head holder 10 and the razor handle 30 as shown in FIG. 3. Additionally, the modular razor 40 can include a razor head or cartridge which is not depicted here. The connector 14 is depicted as an example. All connections for a razor head or cartridge can be combined with the helical screw-in member 18 based connection type disclosed herein.

The assembly of the modular razor 40 starts as depicted in FIG. 2 while FIG. 3 shows the assembled modular razor 40. In the assembled state, the razor handle 30 is screwed upon the screw-in member 18 and resides partially in the handle guide 24. Thus, a stable connection is formed between the razor head holder 10 and the razor handle 30.

In the following, a method of assembling the modular razor 40 is described with reference to FIG. 2.

As shown in FIG. 2, a razor head holder 10 and a razor handle 30 including an engaging portion 32 are provided. The engaging portion 32 comprises or consists of cork.

In a next step, the razor handle 30 is aligned with the engagement axis A of the screw-in member 18 or the razor head holder 10, respectively. The aligning can include moving the razor handle 30 or its engaging portion 32 into the circular handle guide 24 of the razor head holder 10 which surrounds the screw-in member 18.

Then, the razor handle 30 and the razor head holder 10 are relatively rotated to connect the razor head holder 10 and the razor handle 30 by screwing the screw-in member 18 in the razor handle 30. The rotation is executed around the engagement axis A. At the same time, the razor handle 30 can be pushed along the engagement axis A towards the screw-in member 18 or the razor head holder 10.

At the start of the rotating movement, the screw-in member 18 can pierce the end face 34 of the razor handle 30. This can happen after or at the aligning. After a tip of the screw-in member 18 had pierced the end face 34 the razor handle 30 is pulled onto the screw-in member 18 due to its helical shaped body.

The razor handle 30 and the razor head holder 10 are rotated relatively to each other until the razor handle 30 or in other words its end face 34 reaches the stop surface 22 of the razor head holder 10. This connected state of the modular razor 40 is depicted in FIG. 3.

In case the razor handle 30 has been worn off or in case of other reasons, the modular razor 40 can be disassembled again.

In the following, a method of assembling the modular razor 40 is described with reference to FIG. 3 and FIG. 2.

The method of disassembling a razor comprises a first step of providing a razor assembled as described before and depicted in FIG. 3. The assembled razor was achieved by the method of assembling a razor as described before.

In a next step, the razor handle 30 and the razor head holder 10 are relatively rotated in a direction opposite to an assembling direction. This is a direction opposite to the arrows in FIG. 2. The rotational movement can be supported by a longitudinal movement along the engagement axis A.

This rotational movement continues until the razor handle 30 and the razor head holder 10 are disconnected.

The present disclosure also relates to a shaving razor assembly including a modular razor and a razor cartridge as described in the present disclosure. The razor cartridge can be releasably attached to the modular razor, e.g., via a pivotable connection. In other examples, the razor cartridge can be releasably attached to the modular razor via a non-pivotable connection. In still other examples, the razor cartridge can be integrally formed with the modular razor including a pivotable connection. In still other examples, the razor cartridge can be integrally formed with the modular razor including a non-pivotable connection.

The present disclosure also relates to the razor head holders, kits of parts, methods of assembling a razor and methods of disassembling a razor of the following aspects:
1. A razor head holder comprising:
   a holder structure including a connector for a razor head,
   the holder structure further including a helical screw-in member configured for a piercing connection with a razor handle including an engaging portion comprising at least one of cork; a compound of cork, wood, and/or bamboo fiber/power with a plastic matrix; and thermoplastic or thermoset material with a shore hardness between 30A-60D, preferably 70A.
2. The razor head holder according to aspect 1, wherein the screw-in member comprises a helical body along an engagement axis.
3. The razor head holder according to aspect 1 or 2, wherein the screw-in member comprises a tip configured to pierce the engaging portion of the razor handle.
4. The razor head holder according to one of aspects 1 to 3, wherein the screw-in member comprises or consists of steel or plastic material.
5. The razor head holder according to one of aspects 1 to 4, wherein the screw-in member is molded with the holder structure.
6. The razor head holder according to one of aspects 1 to 5, wherein the holder structure comprises a stop surface, wherein the screw-in member is protruding perpendicular from the stop surface and wherein the stop surface provides a stop for a razor handle.
7. The razor head holder according to aspect 6, wherein the stop surface has a size being identical or larger than the size of an end face of the razor handle.
8. The razor head holder according to one of aspect 1 to 7, wherein a handle guide surrounds the screw-in member and is configured to allow rotation of a razor handle.
9. The razor head holder according to aspect 8, wherein the handle guide is provided at a boundary of the stop surface.
10. The razor head holder according to aspect 8 or 9, wherein the handle guide projects farther from the stop surface than the screw-in member.
11. The razor head holder according to one of aspects 6 to 10, wherein the screw-in member has a length of at least a span of the stop surface.
12. The razor head holder according to one of aspects 1 to 11, wherein the screw-in member is located at a side of the holding structure opposite to the connector.
13. A kit of parts, comprising:
   a razor head holder according to any one of the preceding aspects, and
   a razor handle wherein the razor head holder is coupled to the razor handle.
14. The kit of parts according to aspect 13, wherein the razor handle includes an engaging portion comprising at least one of cork; a compound of cork, wood, and/or bamboo fiber/power with a plastic matrix; and thermoplastic or thermoset material with a shore hardness between 30A-60D, preferably 70A and being adapted to be pierced with the screw-in member of the razor head holder.
15. The kit of parts according to aspect 13 or 14, wherein the razor handle consists of at least one of cork; a compound of cork, wood, and/or bamboo fiber/power with a plastic matrix; and thermoplastic or thermoset material with a shore hardness between 30A-60D, preferably 70A.
16. The kit of parts according to one of aspects 13 to 15, wherein the razor handle has an end face with a size being identical or smaller than the size of a stop surface of the razor head holder.
17. The kit of parts according to one of aspects 13 to 16, wherein the razor handle has an end face with a planar surface without a thread for a screw-in member.
18. A method of assembling a razor, comprising the steps of:
   a) providing a razor head holder according to one of aspects 1 to 12,
   b) providing a razor handle including an engaging portion comprising at least one of cork; a compound of cork, wood, and/or bamboo fiber/power with a plastic matrix; and thermoplastic or thermoset material with a shore hardness between 30A-60D, preferably 70A, and
   c) aligning the razor handle with an engagement axis of the screw-in member and relatively rotating the razor handle and the razor head holder to connect the razor head holder and the razor handle by screwing the screw-in member in the razor handle.
19. The method of assembling a razor according to aspect 18, wherein the aligning includes moving the razor handle into a handle guide of the razor head holder which surrounds the screw-in member.
20. The method of assembling a razor according to aspect 18 or 19, wherein the razor handle and the razor head holder are rotated relatively to each other until the razor handle reaches a stop surface of the razor head holder.
21. The method of assembling a razor according to one of aspects 18 to 20, wherein the screw-in member pierces an end face of the razor handle after or at the aligning and wherein the end face has a planar surface without a thread for a screw-in member.
22. A method of disassembling a razor, comprising the steps of:
   a) providing an razor assembled according to the method of one of aspects 18 to 21, and
   b) relatively rotating the razor handle and the razor head holder in a direction opposite to an assembling direction until the razor handle and the razor head holder are disconnected.

1. A razor head holder comprising:
a holder structure including a connector for a razor head,
the holder structure further including a helical screw-in member configured for a piercing connection with a razor handle including an engaging portion comprising at least one of cork; a compound of cork, wood, and/or bamboo fiber/power with a plastic matrix; and thermoplastic or thermoset material with a shore hardness between 30A-60D.

2. The razor head holder according to claim 1, wherein the screw-in member comprises a helical body along an engagement axis.

3. The razor head holder according to claim 1, wherein the screw-in member comprises a tip configured to pierce the engaging portion of the razor handle.

4. The razor head holder according to claim 1, wherein the screw-in member comprises or consists of steel or plastic material.

5. The razor head holder according to claim 1, wherein the screw-in member is molded with the holder structure.

6. The razor head holder according to claim 1, wherein the holder structure comprises a stop surface, wherein the screw-in member is protruding perpendicular from the stop surface and wherein the stop surface provides a stop for a razor handle.

7. The razor head holder according to claim 1, wherein a handle guide surrounds the screw-in member and is configured to allow rotation of a razor handle.

8. The razor head holder according to claim 7, wherein the handle guide projects farther from the stop surface than the screw-in member.

9. The razor head holder according to claim 6 wherein the screw-in member has a length of at least a span of the stop surface.

10. A kit of parts, comprising:
a razor head holder according to claim 1, and
a razor handle wherein the razor head holder is coupled to the razor handle.

11. The kit of parts according to claim 10, wherein the razor handle includes an engaging portion comprising at least one of cork; a compound of cork, wood, and/or bamboo fiber/power with a plastic matrix; and thermoplastic or thermoset material with a shore hardness between 30A-60D, and being adapted to be pierced by the screw-in member of the razor head holder.

12. A method of assembling a razor, comprising the steps of:
a) providing a razor head holder according to claim 1,
b) providing a razor handle including an engaging portion comprising at least one of cork; a compound of cork, wood, and/or bamboo fiber/power with a plastic matrix; and thermoplastic or thermoset material with a shore hardness between 30A-60D, and
c) aligning the razor handle with an engagement axis of the screw-in member and relatively rotating the razor handle and the razor head holder to connect the razor head holder and the razor handle by screwing the screw-in member in the razor handle.

13. The method of assembling a razor according to claim 12, wherein the aligning includes moving the razor handle into a handle guide of the razor head holder which surrounds the screw-in member.

14. The method of assembling a razor according to claim 12, wherein the razor handle and the razor head holder are rotated relatively to each other until the razor handle reaches a stop surface of the razor head holder.

15. A method of disassembling a razor, comprising the steps of:
a) providing a razor assembled according to the method of claim 12, and
b) relatively rotating the razor handle and the razor head holder in a direction opposite to an assembling direction until the razor handle and the razor head holder are disconnected.

16. The method of assembling a razor according to claim 12, wherein the screw-in member pierces an end face of the razor handle after or at the aligning and wherein the end face has a planar surface without a thread for a screw-in member.

17. The razor head holder according to claim 6, wherein the stop surface has a size being identical or larger than the size of an end face of the razor handle.

18. The razor head holder according to claim 7, wherein the handle guide is provided at a boundary of the stop surface.

19. The razor head holder according to claim 1, wherein the screw-in member is located at a side of the holding structure opposite to the connector.

20. The kit of parts according to claim 10, wherein the razor handle consists of at least one of cork; a compound of cork, wood, and/or bamboo fiber/power with a plastic matrix; and thermoplastic or thermoset material with a shore hardness between 30A-60D.
